(19) United States
(12) Patent Application Publication
(10) Pub. No.: US 2016/0143704 A1
(43) Pub. Date: May 26, 2016

(54) HANDLE INSTRUMENT SYSTEM AND METHOD

(71) Applicant: COTESWORTH FISHBURNE, ROCK HILL, SC (US)

(72) Inventor: COTESWORTH FISHBURNE, ROCK HILL, SC (US)

(21) Appl. No.: 14/952,113

(22) Filed: Nov. 25, 2015

Related U.S. Application Data
(60) Provisional application No. 62/085,018, filed on Nov. 26, 2014.
(60) Provisional application No. 62/154,240, filed on Apr. 29, 2015.

(51) Int. Cl. A61C 1/14; A61C 5/00

(52) U.S. Cl. CPC A61C 1/145; A61C 5/00

(57) ABSTRACT

A handle instrument system and method of using the handle instrument system. The handle instrument has a receiver on an end of the handle instrument. The handle instrument receives points directly from a container. The points are positioned generally vertically within the container, and are retained in the container in the generally vertical orientation that permits the points to be conveniently selected and picked from the container using the handle instrument. A point picked from the container and connected to the handle instrument is ready for use. The points are preferably arranged in kits such as containers for ease of identification. In some cases, the points are capable of being manually deformed to a shape and architecture as desired by the operator.

Applicant claims the benefit of Provisional Application Ser. No. 62/085,018 filed Nov. 26, 2014 and Applicant claims the benefit of Provisional Application Ser. No. 62/154,240 filed Apr. 29, 2015.

### FIELD OF THE INVENTION

This invention relates to tools generally, and is more specifically related to handle instruments, methods and systems facilitating use of handle instruments that are useful in medical settings, and particularly, dentistry.

### BACKGROUND OF THE INVENTION

Dentists use instruments to conduct dental operations. Instruments held in the hand are used to place, carve and smooth materials such as dental composites and fillers. Instruments held in the hand may also be used to manipulate, apply or remove cement. Instruments having appropriate tips may be used for applying liquids or gels used in etching and bonding.

Instruments in common use are characterized by metallic handles that are corrosion resistant and require sterilization prior to use. Points or blades are permanently attached to a distal end of the handle instrument. The points or blades are formed and made available in various shapes and sizes, and are used for placing or for shaping materials. Very small brushes present on the distal ends of the points are useful applying etching and bonding materials. These tools are expensive to purchase on an individual basis, and acquiring a wide variety of shapes and sizes of such handle instruments is very expensive. Strict guidance must also be followed in order to ensure safe aseptic use.

Currently, time is wasted as the operator searches through boxes looking for the appropriate point. After the appropriate point is found, it is grasped with tweezers or similar tools, and attached to a handle or other instrument. This process is inefficient.

There is a need for a dental instrument system and method having conveniently interchangeable points. The system should provide points that are conveniently arranged, and may be quickly and easily changed. The system should provide points that are relatively inexpensive for most applications, so that they are disposable. The points in some applications are capable of being manually formed into desired shapes.

### SUMMARY OF THE INVENTION

The present invention is a handle instrument system and method of using the handle instrument system. The handle instrument has a receiver on an end of the handle instrument. The handle instrument receives points directly from a container that is constructed according to the invention. The points are positioned generally vertically within the container, and are retained in the container in the generally vertical orientation that permits the points to be conveniently selected and picked from the container using the handle instrument. A point picked from the container and connected to the handle instrument is ready for use.

The points are preferably arranged in kits such as containers for ease of identification. In some cases, the points are capable of being manually deformed to a shape and architecture as desired by the operator.

### BRIEF DRAWING DESCRIPTION

FIG. 1 shows an embodiment of a handle instrument for use with points for dental operations and showing points having various configurations.

FIG. 2 shows the handle instrument of FIG. 1 picking a point comprising from a retention material that holds the point in a generally vertical position.

FIG. 3 shows the handle instrument of FIG. 1 with a point held thereon after being picked from the retention material.

FIG. 4 shows the handle instrument of FIG. 1 with a point having a distal end formed in a different configuration from that of FIG. 3 and held by the handle instrument after being picked from the container.

FIG. 5 shows a plurality of points in a multiple compartment container, with retention material in the containers, and the openings of the points exposed above the retaining material.

FIG. 6 shows a plurality of points in a multiple compartment container, with retention material in the containers, having another embodiment of the handle instrument and having an embodiment of the points for dental operations.

FIG. 7A shows the embodiment of the handle instrument of FIG. 6 positioned over a vertically standing point held in the retention material.

FIG. 7B shows the embodiment of the handle instrument of FIG. 6 initially engaging a point in the container.

FIG. 7C shows the embodiment of the handle instrument of FIG. 6 rotated to secure the point within the handle instrument by threaded engagement.

FIG. 7D shows the point positioned within the handle instrument and being withdrawn from the retention material.

### DESCRIPTION OF PREFERRED EMBODIMENTS

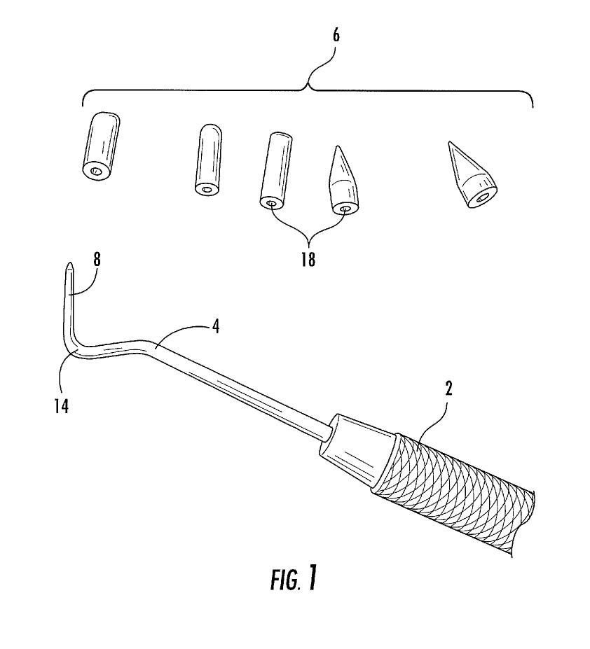

FIG. 1 shows a handle instrument 2 having a rigid wire 4 on the distal end of the handle instrument. It is preferred that the rigid wire not materially deform during use in dental operations with a point 6 attached. The terminal end 8 of the wire as shown is straight, but is formed at an angle to the longitudinal axis of the handle. The angle of the terminal end of the wire is preferred to be from 30 degrees to 75 degrees relative to the longitudinal axis of the handle and is more preferred to be from 45 degrees to 70 degrees relative to the longitudinal axis of the handle. The extreme terminal end is preferred to have a point thereon, with the smaller diameter of the point facilitating insertion of the terminal end of the wire into a void formed in the point selected by the operator. The terminal end also tapers to a smaller dimension from the curve or crook in the wire to the extreme terminal end to facilitate insertion of the wire into the point.

The points 6 for dental operations in this embodiment are preferred to be formed of a flexible, compressible elastomeric material, which may be a polymeric material. The points may be formed of rubbers including saturated rubbers. The points may be formed of closed cell foam, silicone or polyethylene. Each point has a void 18 that opens to the proximal end, with the void providing a female receptacle for the male extension of the handle instrument, which may be the terminal end 8 of a wire as shown in FIG. 1. The longitudinal length of the void is preferred to exceed the length of the terminal end of the wire of the handle instrument, so that the point extends to where the curve 14 of the wire intersects the terminal end. The void is preferred to be positioned in the center of the point. The void does not extend to the distal end of the point.

The mechanism of attachment of the handle instrument to the points in the embodiment of FIG. 1 is a frictional fit. In an embodiment, the male extension at the distal end of the handle instrument is correspondingly larger than the receptacle diameter of the flexible, elastomeric point, which may be formed of a polymeric material. The male extension at the distal end of the handle instrument having a point formed in the extreme terminal end is inserted in the receptacle, and at least the upper portion of the male extension compresses the material from which the point is formed. The compression of the material against the male extension provides a frictional fit that retains the point on the handle instrument for use.

The proximal end of the points 6 may comprise a chamfered opening in the receptacle to assist insertion of the male extension of the handle instrument. The chamfered opening may lead to a cylindrical receptacle. The diameter of the cylindrical receptacle may be approximately equal to the thickness of the wall of the point where the receptacle exists. The point may be formed of an elastomeric polymer having a durometer range that is sufficiently soft to permit compliance of the point when the point is installed on the instrument handle.

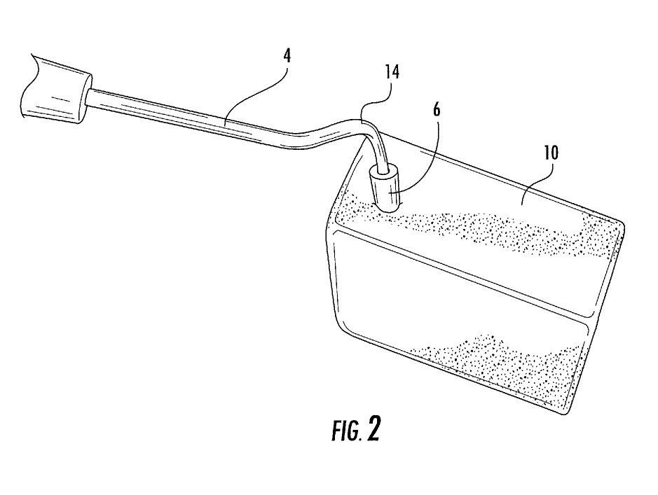

As shown in FIG. 2, a selected point is installed by pushing the terminal end of the handle instrument into the cylindrical opening of the point. The points are held in a generally vertical configuration in the retention material 10. The proximal ends of the points extend above a top plane of the retention material. In some embodiments, the proximal ends of the points are larger than the distal ends of the points and are larger than the openings to the pockets 12 to resist being pushed into the pockets as the handle instrument engages the point.

The points may vary in design at the distal end. The form and construction of the points is selected according to the dental operation to be performed. Some preferred embodiments of the distal end of the point include a wedge shape, a ball or generally cylindrical point, a flat round, a pointed end, a conical shape, an irregular shape and a generally flat paddle shape. The overall size may also be selected according to application.

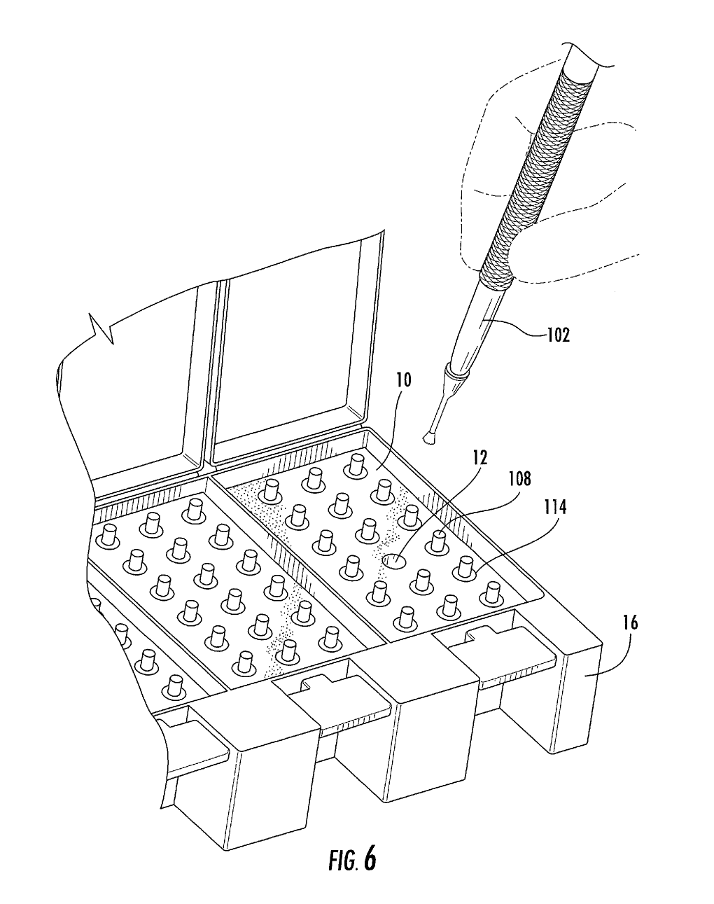

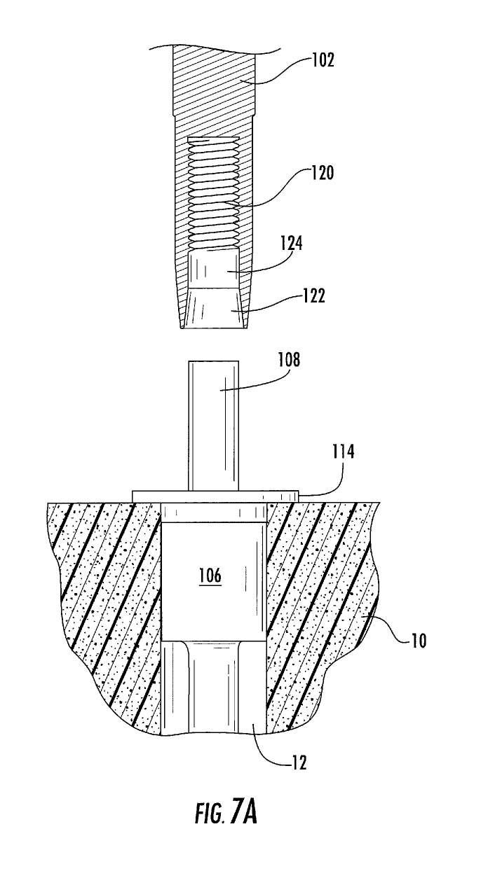

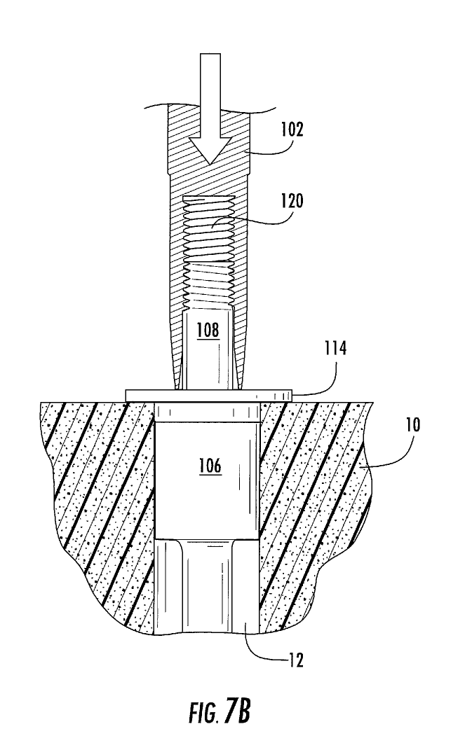

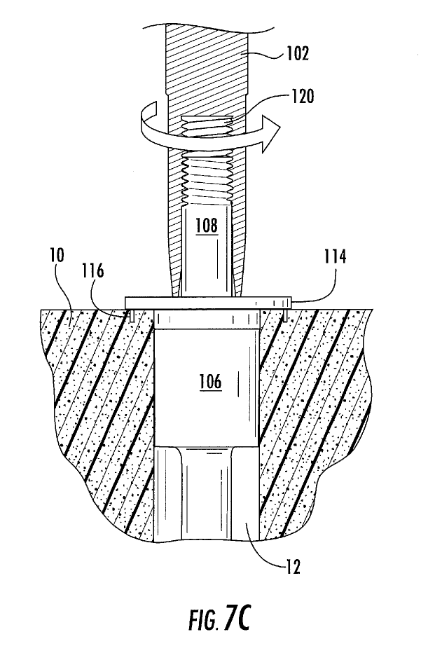

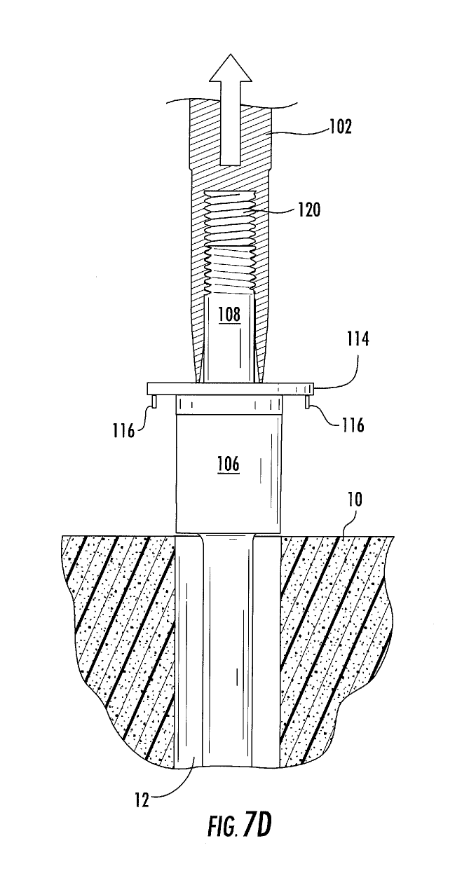

FIG. 6 and FIGS. 7 A-D show another embodiment of the handle instrument 102. The handle instrument of this embodiment is useful for picking points 106 having a male extension, such as stem 108. As shown in FIG. 6, the handle instrument has a female receptacle in the distal end of the handle instrument. The male extension or stem of the points is retained within the receptacle of the handle instrument. A selected point may be picked from the retention material and container, and used to perform a dental operation while retained within the handle instrument. The points may be constructed in configurations on the distal end that are useful to particular dental operations, such as the distal ends shown in FIG. 1, which are non-limiting examples.

The stem 108 may be formed as a round cross section on an upper, or proximal, end thereof. The points may be disposed in the retention material 10, with the upper or proximal end of the stem, extending above the top surface or top plane of the retention material, with the points held generally vertically in the retention material. The retention material may be positioned in a container 16 as shown in FIG. 6.

The handle instrument 102 as shown in FIGS. 6 and 7 A-D has a threaded receptacle 120 in a distal end thereof. In one embodiment, the receptacle has a relatively wide opening 122 at the terminal end, which may be frusto-conically shaped as shown. The wide opening, such as the frusto-conical shape, encourages insertion of the point into the receptacle, and guides the proximal end of the point towards a threaded portion of the receptacle in the handle. In the embodiment shown, a cylindrical non-threaded portion 124 of the receptacle assists in aligning and guiding the stem to the threads. The dimensions of the opening 122, portion 124 and threaded portion 120 will depend upon the dimensions of the stem. In a preferred embodiment, the threads occupy not less than 4 mm of the overall length of the receptacle.

In one embodiment, the proximal end of the stem 108 of the point abuts the threaded portion 120 of the receptacle as the receptacle is placed over the stem, with the stem meeting little resistance until abutting the threads of the receptacle. FIG. 7B. The proximal end of the stem of the point and the threads of the handle are similarly dimensioned for engagement of the resilient stem with the threads. The stem in preferred embodiments is not threaded prior to engagement with the threads. FIG. 7 A. The handle is rotated until the stem of the point is felt to have engaged the threads. FIG. 7C. Rotation of 4 or 5 turns generally provides adequate engagement of the point with the handle instrument, meaning that engagement is quick and easy for the operator when selecting and engaging a point with the handle instrument. Such rotation is generally adequate in a preferred embodiment with resilient and deformable stems that are properly dimensioned according to the threads.

The point attached as described above may then be lifted from the container. FIG. 7D. If desired, a manual rotational force may be applied to the point after removal of the point from the container, while giving the point a slight pull, to verify that the point is secured prior to using the point in a dental or medical operation. Manual counter rotation of the point disengages the point from the threads of the handle instrument.

In another embodiment of the handle instrument, the threads of the receptacle extend to the terminal and distal end of the handle instrument. As could also be true with the embodiment of FIG. 7A, only a small portion of the opening is threaded, since it is preferred that engagement of the threads with the stem of the point occur with minimal rotation of the handle, as described herein. After contact of the threads with the stem of the point, the method of engagement is as shown in FIG. 7C.

The stems of the points are resilient, and engage the threads of the handle. The stem may be formed of a plastic material, such as polypropylene or polyethylene, which is resilient and deforms to securely engage with the threads formed in the much harder handle instrument, which is preferred in all embodiments to be formed of a non-corrosive or corrosive resistant material such as stainless steel. This combination enables secure threaded engagement of the point with the handle instrument, as described herein, with minimal rotation of the handle, providing quick connection of the point to the handle instrument. The dimensions of the stem relative to the threads of the handle, and the selected material for the stem, will cause the terminal and proximal end of the stem to be deformed by the threads of the handle, with the stem engaging the threads. The point is held in the handle by rotation of the handle after the stem in the container makes initial contact with the threads as described herein.

The handle instrument of the embodiments may be formed of chrome plated stainless steel or other corrosion resistant metals that are autoclavable. The handle may comprise copper and/or silver, which are known to have antimicrobial properties. The handle is preferred to be 10-18 cm in length, with a round cross section along its length. Knurling or similar roughening of the surface of the handle along a length nearest the proximal end aids in gripping the handle. The outer diameter of the distal end that houses the opening is about 4-6 mm, with the diameter of the internal opening that is between the frusto-conical portion and the threads being about 0.5 mm less than the outer diameter in an embodiment of the handle instrument having a threaded receptacle. For example, the threads may be SAE 4-40, M3×0.6 or M3.5×0.6. The dimensions of the handle, as well as the threads, are sized according to the application requirement, and the examples herein are suitable for many medical and dental operations.

The stem of the point is matched to the dimension of the opening and/or threads of the handle. If the portion 124 of the opening is about 3.0 mm, the stem of the points useful with the handle will also be about 3.0 mm, or slightly less, since the stems are formed of a material that is softer than and is deformable by threads formed in a metal handle.

The construct of the distal end of the points used may be varied. The proximate ends of the points may be coded according to the construct of the points and/or size of the points. Indicia such as letters, numbers, designs or colors may be used for coding.

The retention material 10 holds the points in a generally vertical position for engagement of the handle instrument with the points. The retention material and the pockets 12 in the retention material for the embodiment shown in FIGS. 6 and 7 A-D must be constructed and arranged to retain the points so as to resist rotation of the points within the container as the handle is rotated to engage the stem of the points, yet permit the points to be withdrawn vertically from the container. The points 106 may be formed with an enlarged collar 114 that prevents the stem of the points from being pushed below the surface of the retention material. Lugs 116 may be formed on at least generally two opposing sides of the collar that engage the rendition material so as to resist rotation of the point 106 as the handle instrument is attached.

The retention material is formed with a plurality of generally vertical pockets 12. Preferably, one point is inserted into and retained by one pocket in the retention material and disposed generally vertically until the point is picked by the handle instrument for use. The retention material may be formed of closed cell foam, extruded or expanded polystyrene foam, or of a polymer such as silicone.

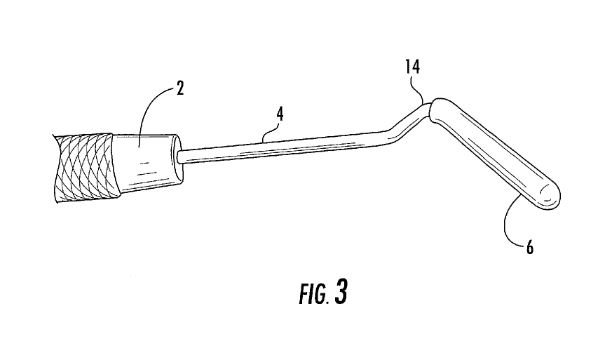

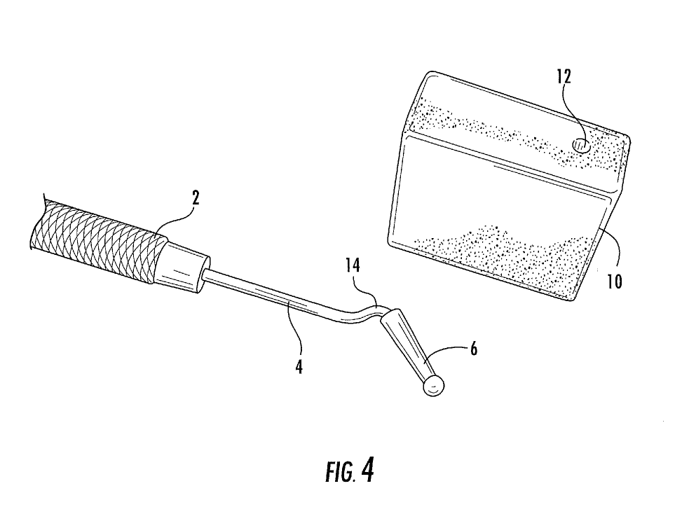

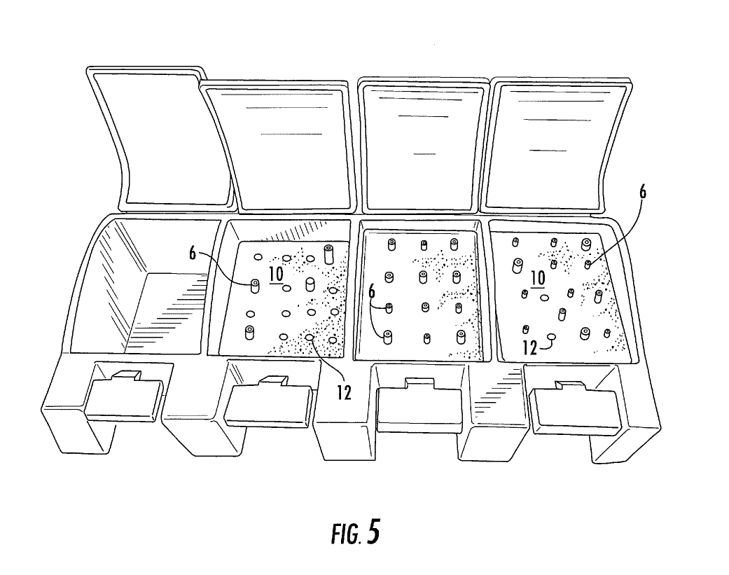

In a preferred embodiment, the retention material is a block formed of polystyrene, such as the polystyrene material used for building insulation. Pockets may be formed in the block of polystyrene by a punch that forms the pockets to a depth that allows the proximal end of the point that is placed in the pocket to extend above a top surface of the pocket. The polystyrene may have a pressure resistance of 15 to 25 lbs. For the embodiment shown in FIGS. 1-5, the polystyrene provides resistance for pushing the handle instrument into the point. Other materials having similar properties may be used.

For the embodiment shown in FIGS. 6-7D the polystyrene provides resistance for pushing the handle instrument over the point and onto the threads, while the pocket is also sized to provide frictional contact to the sides of the points for resisting rotation of the points while threading the handle instrument onto the points. For example, the point may be slightly larger than the pocket, pushing against the deformable foam material. This deformation and elasticity of the foam grips the point sufficiently to resist rotation of the point by the handle instrument during the threading process. Other materials having similar properties may be used.

Since the points in many cases are formed of inexpensive plastics and metals, the points may be discarded after use, which is more cost effective than sterilizing the points. Only the handle instrument is retained, which may be sterilized for subsequent use. The handle instrument is useful with multiple constructs and configurations of points.

The container for the points is designed so that a new supply of points may be installed when the supply is exhausted without the medical or dental office replacing individual points in the upright position for withdrawal. The points may be machine loaded into the retention material at a factory, and supplied to the dental office for positioning into the container. The container may be constructed and arranged to accommodate a single retention material member having points positioned in the pockets, or it may be constructed and arranged to comprise multiple compartments.

A disposable waste receptacle is useful with the invention. After use, points are removed from the handle instrument. Points may be collected by the waste receptacle for easy disposal. Most dental offices have trays upon which hand pieces and other instruments are placed. The tray is covered with a disposable paper sheet. The receptacle has a pressure sensitive adhesive coated on the bottom of the receptacle that is used to attach the waste receptacle to the paper. The waste receptacles may be stacked so that the adhesive does not contact adjacent cups, or a peel off covering may be provided over the adhesive. After completion of the dental operation, the paper sheet, and the receptacle containing the used points, may be disposed of as a unit.

In use, a container is constructed or obtained having a plurality of points for dental operations disposed generally vertically in the container as described in one of the embodiments herein. The operator manually grasps a handle instrument as described herein, and selects a point from the plurality of points for retrieval from the container. The distal end of the handle instrument engages a proximal end of the point selected.

The operator retrieves the point selected from the container by pulling the handle instrument away from the container, with the point selected engaged with the handle instrument. The operator may manually verify engagement of the point with the handle instrument after the handle instrument pulls the point out of the container. Engagement of the point with the handle instrument does not require touching the point. The operator may then perform a dental operation with the point selected and engaged with the handle instrument.

What is claimed:

1. A method of affixing a selectable dental point on a handle instrument, comprising the steps of:
obtaining a container having a plurality of points for dental operations positioned generally vertically in the container;
manually grasping a handle instrument;
selecting a point from the plurality of points for dental operations for retrieval from the container;
engaging a distal end of the handle instrument with a proximal end of the point selected;
retrieving the point selected from the container by pulling the handle instrument away from the container with the point selected engaged with the handle instrument; and
performing a dental operation with the point selected and engaged with the handle instrument.

2. A method of affixing a selectable dental point on a handle instrument as described in claim 1, comprising the addition steps, prior to the step of obtaining a container having a plurality of points for dental operations, of:
forming a retention material;
forming a plurality of pockets in the retention material;
positioning one point of the plurality of points in each pocket of the plurality of pockets formed in the rendition material, with the plurality of points held in the plurality of pockets in a generally vertical orientation, with the proximal ends of the plurality of points for dental operations extending above a top surface of the retention material; and
positioning the retention material in the container.

3. A method of affixing a selectable dental point on a handle instrument as described in claim 2, wherein the retention material comprises polystyrene foam.

4. A method of affixing a selectable dental point on a handle instrument as described in claim 2, wherein the retention material comprises silicone.

5. A method of affixing a selectable dental point on a handle instrument as described in claim 1, wherein the container having a plurality of points for dental operations positioned generally vertically in the container comprises a retention material, wherein the retention material has a plurality of pockets therein, with one point of the plurality of points for dental operations positioned held in each pocket of the plurality of pockets in a generally vertical orientation, with the proximal ends of the plurality of points for dental operations extending above a top surface of the retention material.

6. A method of affixing a selectable dental point on a handle instrument as described in claim 5, wherein the retention material comprises polystyrene foam.

7. A method of affixing a selectable dental point on a handle instrument as described in claim 5, wherein the retention material comprises silicone.

8. A method of affixing a selectable dental point on a handle instrument as described in claim 1, wherein a first point of the plurality of points for dental operations has a structure on a distal end of the first point that is different than a structure of a distal end of a second point plurality of points for dental operations, and wherein the first point has a first code and the second point has a second code that is different from the first code, and wherein the first code and the second code are visible when the first point and the second point are positioned generally vertically in the container.

9. A method of affixing a selectable dental point on a handle instrument as described in claim 8, wherein the first code is a first color and the second code is a second color that is different from the first color.

10. A method of affixing a selectable dental point on a handle instrument as described in claim 1, wherein the handle instrument has a male extension on the distal end of the handle instrument, and the plurality of points each have a female receptacle formed in a proximal end thereof, wherein the male extension of the handle instrument engages the female receptacle of the point selected from the plurality of points and the handle instrument holds the point selected from the plurality of points for retrieval of the point from the container by pulling the handle instrument away from the container.

11. A method of affixing a selectable dental point on a handle instrument as described in claim 10, wherein the angle of the male extension is from 30 degrees to 75 degrees from the longitudinal axis of the handle instrument.

12. A method of affixing a selectable dental point on a handle instrument as described in claim 1, wherein the handle instrument has female receptacle formed in a distal end of the handle instrument, and the plurality of points each have a male extension formed in a proximal end thereof, wherein the male extension of the point selected from the plurality of points engages the female receptacle of the handle instrument and the handle instrument holds the point selected from the plurality of points for retrieval of the point from the container by pulling the handle instrument away from the container.

13. A method of affixing a selectable dental point on a handle instrument as described in claim 1, wherein the handle instrument has a threaded female receptacle formed in a distal end of the handle instrument, and the plurality of points each have a male extension formed in a proximal end thereof, wherein the male extension of the point selected from the plurality of points engages the female receptacle of the handle instrument by threaded engagement and the handle instrument holds the point selected from the plurality of points by threaded engagement for retrieval of the point from the container by pulling the handle instrument away from the container.

14. A method of affixing a selectable dental point on a handle instrument as described in claim 1, wherein the handle instrument has a threaded female receptacle formed in a distal end of the handle instrument, and the plurality of points each have a male extension formed in a proximal end thereof, wherein the male extension of the point selected from the plurality of points engages the female receptacle of the handle instrument;
further comprising the step of rotating the handle instrument with the male extension of the point selected present in the threaded receptacle of the of the handle instrument and forming threads in the male extension of the point selection by rotation of the handle instrument;
wherein a threaded engagement of the handle instrument with the point selected from the plurality of points holds the point selected by threaded engagement for retrieval of the point from the container by pulling the handle instrument away from the container.

15. A method of affixing a selectable dental point on a handle instrument as described in claim 12, wherein a distal end of the handle instrument comprises stainless steel and the proximal end of the plurality of points comprises polypropylene.

16. A method of affixing a selectable dental point on a handle instrument as described in claim 13, wherein the threaded female receptacle of the handle instrument comprises stainless steel and the proximal end of the plurality of points comprises polypropylene.

17. A method of affixing a selectable dental point on a handle instrument as described in claim 14, wherein the threaded female receptacle of the handle instrument comprises stainless steel and the proximal end of the plurality of points comprises polypropylene.

18. A method of affixing a selectable dental point on a handle instrument as described in claim 5, wherein the point has a collar formed thereon that is positioned above the top surface of the retention material when the point is positioned in the pocket of the retention material.

19. A method of affixing a selectable dental point on a handle instrument as described in claim 10, wherein the plurality of points is formed of an elastomer.
